(19) United States
(12) Patent Application Publication
(10) Pub. No.: US 2020/0278593 A1
(43) Pub. Date: Sep. 3, 2020

(54) VIBRATION OPTICAL MODULE AND PROJECTOR

(71) Applicant: Coretronic Corporation, Hsin-Chu (TW)

(72) Inventors: Shu-Yu Lin, Hsin-Chu (TW); Chi-Tang Hsieh, Hsin-Chu (TW); Ken-Teng Peng, Hsin-Chu (TW)

(73) Assignee: Coretronic Corporation, Hsin-Chu (TW)

(21) Appl. No.: 16/798,418

(22) Filed: Feb. 23, 2020

(30) Foreign Application Priority Data
Feb. 28, 2019 (CN) 201910148293.0

(51) Int. Cl. G03B 21/14; G03B 21/28

(52) U.S. Cl. CPC G03B 21/142; G03B 21/28

(57) ABSTRACT

A vibration optical module includes a base, a first frame, an optical component, and an actuating assembly. The first frame has at least one first shaft portion. The first frame is connected to the base at least by the at least one first shaft portion. The optical component is disposed in the first frame. The actuating assembly is disposed on the base. The Young's modulus of the material of the base is higher than that of the material of the at least one first shaft portion. The actuating assembly drives the first frame to drive the optical component to vibrate back and forth relatively to the base within an angle by elastic deformation of the at least one first shaft portion. The vibration optical module can save configuration space. A projector having the vibration optical module is also provided. The vibration optical module of the projector can save configuration space.

### CROSS-REFERENCE TO RELATED APPLICATION

This application claims the priority benefit of China application serial no. 201910148293.0, filed on Feb. 28, 2019. The entirety of the above-mentioned patent application is hereby incorporated by reference herein and made a part of this specification.

### BACKGROUND OF THE INVENTION

### Field of the Invention

The present invention relates to an optical module and a projector, and more particularly to a vibration optical module and a projector having the same.

### Description of Related Art

A projection device is a display device for generating a large-sized image. The imaging principle of the projection device is to convert the illumination beam generated by the light source into an image beam by a light valve, and then project the image beam onto the screen or the wall by the lens.

For products in current markets, the resolution of the image converted by the light valve has gradually failed to meet the market demand. In order to further enhance the image resolution, a high-resolution light valve can be used in the projection device, but such projection device is expensive to manufacture. Moreover, in some projection devices, an optical module with optical vibration technology can be additionally configured to further enhance the resolution of the image converted by the light valve. The optical module generally includes a base and a frame disposed in the base, and the frame is configured to carry the light transmitting component or the light reflecting component and can be driven to vibrate. Thus, the image beam passing through the light-transmitting component or reflecting by the light-reflecting component thereby achieve enhanced image resolution by the vibrations.

In the optical module, the base is generally a plastic component and needs to have sufficient thickness to provide structural strength. The base and the frame are generally combined in a screw mounting manner by pairs of male-female threads, where sufficient thickness of the base or frame is required for screw mounting. However, in the case of a mini projection device, the space in which the optical module is disposed is limited, and the thickness of the optical module needs to be reduced to be used for a mini projection device. In addition, in the case that the base and the frame are made of metal for improving the structural strength of the base and the frame, the metal material connecting the base and the frame will generate excessively loud noises when the frame vibrates relatively to the base.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention provides a vibration optical module, and the vibration optical module can save configuration space.

The invention provides a projector, a vibration optical module of the projector can save configuration space.

Other objectives and advantages of the invention can be further illustrated by the technical features broadly embodied and described as follows.

To achieve at least one of the above-mentioned objectives or other objectives, an embodiment of the invention provides a vibration optical module including a base, a first frame, an optical component, and an actuating assembly. The first frame has at least one first shaft portion. The first frame is connected to the base at least by the at least one first shaft portion. The optical component is disposed in the first frame. The actuating assembly is disposed on the base. The Young's modulus of the material of the base is higher than the Young's modulus of the material of the at least one first shaft portion. The actuating assembly drives the first frame to drive the optical component to vibrate back and forth relatively to the base within an angle by elastic deformation of the at least one first shaft portion.

To achieve at least one of the above-mentioned objectives or other objectives, an embodiment of the invention provides a projector including a light source, a light valve, a projection lens, and a vibration optical module. The light source is adapted to provide an illumination beam. The light valve is adapted to convert the illumination beam into an image beam. The projection lens is adapted to project the image beam. The vibration optical module is disposed between the light valve and the projection lens and includes a base, a first frame, an optical component, and an actuating assembly. The first frame has at least one first shaft portion. The first frame is connected to the base at least by the at least one first shaft portion. The optical component is disposed in the first frame. The actuating assembly is disposed on the base. The Young's modulus of the material of the base is higher than the Young's modulus of the material of the at least one first shaft portion. The actuating assembly drives the first frame to drive the optical component to vibrate back and forth relatively to the base within an angle by elastic deformation of the at least one first shaft portion.

Based on the above description, the embodiments of the invention have at least one of the following advantages or effects. In the vibration optical module of the present invention, since the base is made of a material having a higher Young's modulus, it can provide sufficient structural strength with a less thickness to effectively save the configuration space. Further, the shaft portion of the frame is made of a material having a lower Young's modulus, it would prevent the shaft portion from generating excessively loud noises when the frame vibrates.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic block diagram illustrating a projector according to one embodiment of the invention.

FIG. 2 is a perspective view of the vibration optical module of FIG. 1.

FIG. 3 is an exploded view of the vibration optical module of FIG. 2.

FIG. 4 is a plan view illustrating partial components of the vibration optical module of FIG. 2.

FIG. 5 is a perspective view of a vibration optical module according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

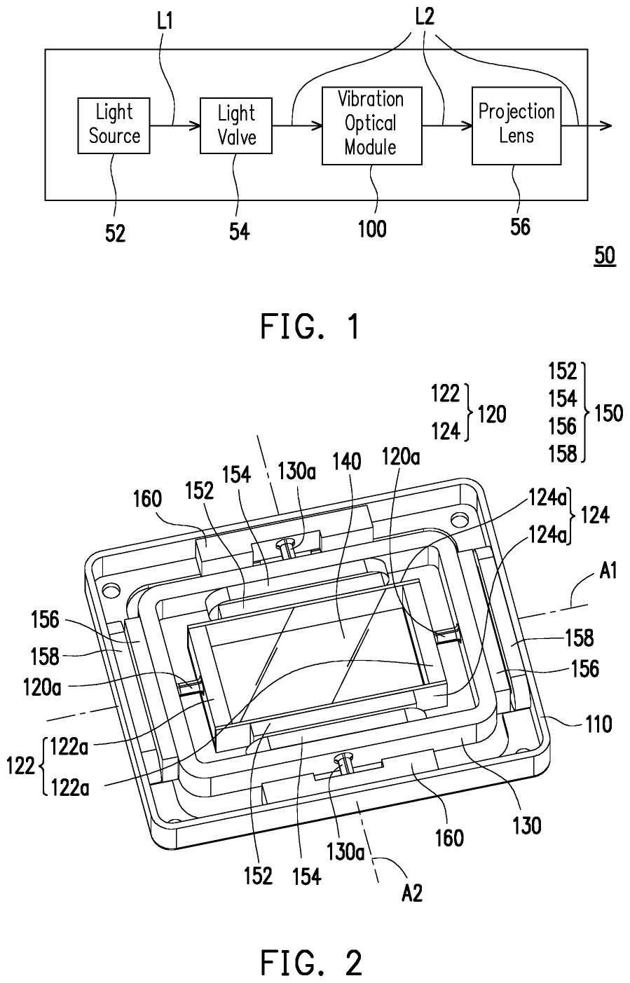

FIG. 1 is a schematic block diagram illustrating a projector according to one embodiment of the present invention. Referring to FIG. 1, the projector 50 includes a light source 52, a light valve 54, a projection lens 56, and a vibration optical module 100. The light source 52 is adapted to provide an illumination beam L1. The light valve 54 is, for example, a digital micro-mirror device (DMD) and is adapted to convert the illumination light beam L1 into an image light beam L2. The projection lens 56 is adapted to project the image light beam L2 out of the projector 100 to form a projected image. The vibration optical module 100 is disposed between the light valve 54 and the projection lens 56 for enhancing the resolution of the image light beam L2 converted by the light valve 54.

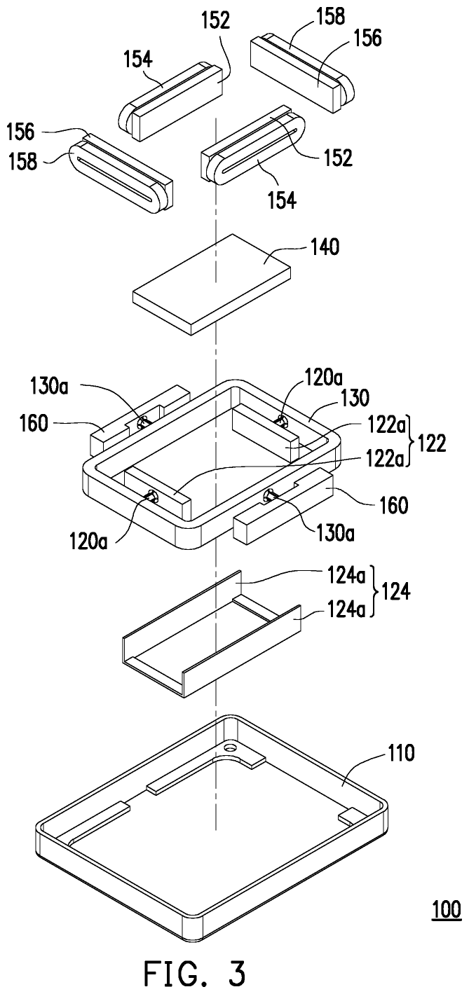

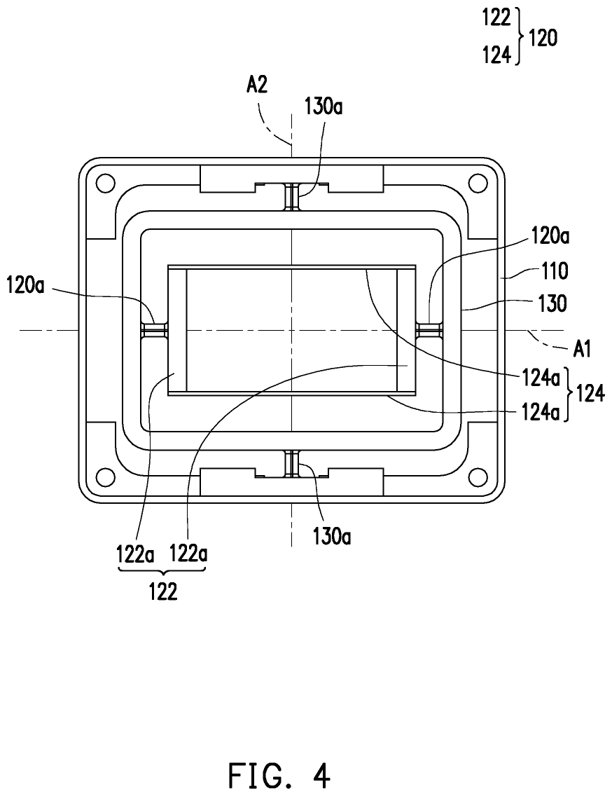

FIG. 2 is a perspective view of the vibration optical module of FIG. 1. FIG. 3 is an exploded view of the vibration optical module of FIG. 2. FIG. 4 is a plan view illustrating partial components of the vibration optical module of FIG. 2. Referring to FIG. 2 to FIG. 4, in the embodiment, the vibration optical module 100 includes a base 110, a first frame 120, a second frame 130, an optical component 140, and an actuating assembly 150. The first frame 120 has at least one first shaft portion 120a (shown as two), and the second frame 130 has at least one second shaft portion 130a (shown as two). The second frame 130 is disposed in the base 110 and is connected to the base 110 at least by each of the second shaft portions 130a. The first frame 120 is disposed in the second frame 130 and is connected to the second frame 130 by each of the first shaft portions 120a. That is, the first frame 120 is connected to the base 110 at least by each of the first shaft portions 120a thereof, the second frame 130 and each of the second shaft portions 130a of the second frame 130. In the embodiment, the first frame 120 has two first shaft portions 120a disposed along the rotation axis A1. The first frame 120 can rotate around the rotation axis A1 (i.e., the axial direction of the first shaft portion 120a) relatively to the second frame 130 and the base 110 by the two first shaft portions 120a. The second frame 130 has two second shaft portions 130a disposed along the rotation axis A2. The second frame 130 can rotate around the rotation axis A2 (i.e., the axial direction of the second shaft portion 130a) relatively to the base 110 by the two second shaft portions 130a. The optical component 140 is, for example, a light transmitting component or a light reflecting component and is disposed in the first frame 120. In the present embodiment, the optical component 140 is a light transmitting component that allows the image beam L2 from the light valve 54 to pass.

The actuating assembly 150 is disposed in the base 110 to drive the first frame 120 and the second frame 130 to vibrate. In detail, the actuating assembly 150 can include at least one first magnet 152 (shown as two), at least one first coil 154 (shown as two), at least one second magnet 156 (shown as two) and at least one second coil 158 (shown as two). The first magnet 152 is disposed on the first frame 120, and the first coil 154 is disposed on the second frame 130 and aligned to the first magnet 152. The second magnet 156 is disposed on the second frame 130, and the second coil 158 is disposed on the base 110 and aligned to the second magnet 156. A magnetic force can be generated between each of the first magnets 152 and the corresponding first coil 154, so as to drive the first frame 120 to drive the optical component 140 to vibrate back and forth relatively to the second frame 130 and the base 110 along the rotation axis A1 within an angle by elastic deformation of each of the first shaft portions 120a. A magnetic force can be generated between each of the second magnets 156 and the corresponding second coil 158 to drive the second frame 130 to drive the optical component 140 to vibrate back and forth relatively to the base 110 along the rotation axis A2 which is perpendicular to rotation axis A1 within an angle by elastic deformation of each of the second shaft portions 130a. Therefore, the effect of enhancing the resolution of the image light beam L2 passing through the optical component 140 can be achieved.

In the embodiment, the Young's modulus of the material of the base 110 is higher than the Young's modulus of the material of each of the first shaft portions 120a and the Young's modulus of the material of each of the second shaft portions 130a. Therefore, the base 110 with a higher Young's modulus can provide sufficient structural strength with a less thickness to effectively save the configuration space. Further, each of the first shaft portions 120a of the first frame 120 and each of the second shaft portions 130a of the second frame 130 with a lower Young's modulus can be prevented from generating excessively loud noises when the first frame 120 and the second frame 130 vibrate.

In this embodiment, the material of the base 110 is, for example, metal, which may be a sheet metal such as a chrome-plated steel plate (SECC) or a stainless steel plate (SUS), or a die-cast metal such as an aluminum alloy (Al, ADC12) or a zinc-aluminum alloy (ZnAl), so as to have a less thickness. Besides, the material of a part of the first frame 120 and each of the first shaft portions 120a thereof is, for example, a plastic material such as polycarbonate (PC), polyetherimide (PEI), or polyetheretherketone (PEEK). The material of the second frame 130 and each of the second shaft portions 130a thereof is also, for example, a plastic material such as polycarbonate (PC), polyetherimide (PEI), or polyetheretherketone (PEEK). In other embodiments, the above components may be made of other proper materials, which are not limited by the present invention.

In the embodiment, the vibration optical module 100 further includes at least one connecting structure 160 (shown as two). The material of each of the second shaft portions 130a is the same as the material of the corresponding connecting structure 160, and each of the second shaft portions 130a is integrally formed on the corresponding connecting structure 160. Each of the connecting structure 160 is integrally formed on the base 110 by, for example, insert injection molding, ultrasonic welding, thermal fusion, or gluing. In the embodiment, the second frame 130 is connected to the base 110 at least by each of the second shaft portions 130a and each of the connecting structures 160.

On the other hand, in the embodiment, the first frame 120 includes a first frame portion 122 and a second frame portion 124. The first frame portion 122 and the second frame portion 124 are connected to each other and surround the optical component 140 together to support and fix the optical component 140. The material of each of the first shaft portions 120a is the same as the material of the first frame portion 122, and each of the first shaft portions 120a is integrally formed on the first frame portion 122. The Young's modulus of the material of the second frame portion 124 is higher than the Young's modulus of the material of the first frame portion 122 and each of the first shaft portions 120a, so that the first frame 120 can have stronger structural strength by the second frame portion 124. The material of the first frame portion 122 is, for example, a plastic material such as polycarbonate (PC), polyetherimide (PEI), or polyetheretherketone (PEEK). The second frame portion 124 may be a sheet metal such as a chrome-plated steel plate (SECC) or a stainless steel plate (SUS), or a die-cast metal such as an aluminum alloy (Al, ADC12) or a zinc-aluminum alloy (ZnAl), so as to have a less thickness for effectively reducing the thickness of the first frame 120 along the axial direction A2. More specifically, the first frame portion 122 includes two first sidewalls 122a opposite to each other, and the second frame portion 124 includes two second sidewalls 124a opposite to each other. Each of the first sidewalls 122a is integrally connected between the two second sidewalls 124a by, for example, insert injection molding, ultrasonic welding, thermal fusion, or gluing. The two first sidewalls 122a and the two second sidewalls 124a surround and form a rectangular space to accommodate the optical component 140 which, for example, may be a rectangular shape. In other embodiments, the first frame 120 and the optical component 140 may be other proper shapes, which are not limited by the present invention. In the embodiment, one ends of the two first shaft portions 120a are connected to the two first sidewalls 122a of the first frame portion 122, and the other ends thereof are connected to the second frame 130. One ends of the two second shaft portions 130a are connected to two opposite side walls (not labeled) of the second frame 130, and the other ends thereof are respectively connected to the two connecting structures 160.

In the embodiment, each of the first sidewalls 122a, each of the first shaft portions 120a, the second frame 130, each of the second shaft portions 130a, and each of the connecting structures 160 may be made of the same material (such as the same plastic material), each of the second sidewalls 124a and the base 110 may be made of the same material (for example, the same metal material), and these plastic material and the metal material are coupled together by the above mentioned methods, for example, insert injection molding, ultrasonic welding, thermal fusion, or gluing, to make the base 110, the first frame 120 and the second frame 130 an integrated structure as a whole. Therefore, the first frame 120 and the second frame 130 are connected to the base 110 in a non-screw-mounting manner, so that the first frame 120, the second frame 130 and the base 110 are not necessarily designed to be bulky in order to provide sufficient thickness for screws.

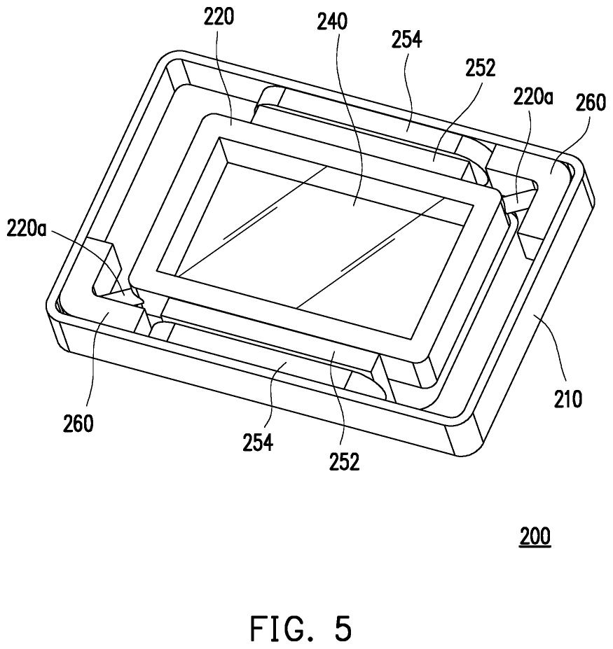

FIG. 5 is a perspective view of a vibration optical module in accordance with another embodiment of the present invention. In the vibration optical module 200 shown in FIG. 5, the configuration and the function of the base 210, the first frame 220, the first shaft portion 220a, the optical component 240, the first magnet 252, the first coil 254, and the connecting structure 260 are similar to the configuration and the function of the base 110, the first frame 120, the first shaft portion 120a, the optical component 140, the first magnet 152, the first coil 154, and the connecting structure 160 in FIG. 2 to FIG. 4, therefore, will not be repeated here. The vibration optical module 200 is different from the vibration optical module 100 in that the vibration optical module 200 does not have components like the second frame 130 and the second shaft portion 130a thereof in the vibration optical module 100. That is, the vibration optical module 200 vibrates in a uniaxial way, while the vibration optical module 100 vibrates in a biaxial way. Accordingly, the vibration optical module 200 does not have the components like the second magnet 156 and the second coil 158 in the vibration optical module 100.

The material of each of the first shaft portions 220a of the first frame 220 is, for example, the same as the material of the corresponding connecting structure 260 (for example, the same plastic material), and each of the first shaft portions 220a is integrally connected with the corresponding connecting structure 260 directly. The connecting structure 260 of the present embodiment is integrally connected to the base 210 (for example, a metal material) by, for example, insert injection molding, ultrasonic welding, thermal fusion, or gluing, similar to the connecting structure 160 in the vibrating optical module 100. Therefore, the base 210 and the first frame 220 form an integral structure and are connected in a non-screw-mounting manner. In addition, the entire first frame 220 of the present embodiment is, for example, the same material (for example, a plastic material), unlike the first frame portion 122 and the second frame portion 124 of the first frame 120 in the vibration optical module 100 are respectively made of different material. However, the present invention is not limited thereto.

In summary, the embodiments of the present invention have at least one of the following advantages or benefits. In the vibration optical module of the present invention, since the base or the base and the partial frame are made of a material having a higher Young's modulus, it can provide sufficient structural strength with a less thickness to effectively save the configuration space. Further, the shaft portions of the frame are made of a material having a lower Young's modulus, it would prevent the shaft portions from generating excessively loud noises when the frame vibrates. Moreover, since the base and the frame are integrally coupled in a non-screw-mounting manner, thus, the frame and the base are not necessarily designed to be bulky in order to provide sufficient thickness for screws.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A vibration optical module, comprising a base, a first frame, an optical component, and an actuating assembly, wherein,
the first frame has at least one first shaft portion, wherein the first frame is connected to the base at least by the at least one first shaft portion,
the optical component is disposed in the first frame, and
the actuating assembly is disposed on the base,
wherein the Young's modulus of the material of the base is higher than the Young's modulus of the material of the at least one first shaft portion, and the actuating assembly drives the first frame to drive the optical component to vibrate back and forth relatively to the base within an angle by elastic deformation of the at least one first shaft portion.

2. The vibration optical module according to claim 1, wherein the vibration optical module further comprises a second frame, wherein the first frame is disposed in the second frame and connected to the second frame by the at least one first shaft portion, the second frame has at least one second shaft portion, the second frame is connected to the base at least by the at least one second shaft portion, the actuating assembly drives the second frame to drive the optical component to vibrate back and forth relatively to the base within an angle by elastic deformation of the at least one second shaft portion, and the Young's modulus of the material of the base is higher than the Young's modulus of the material of the at least one second shaft portion.

3. The vibration optical module according to claim 2, wherein the vibration optical module further comprises at least one connecting structure, wherein the at least one connecting structure is disposed on the base, the at least one second shaft portion is connected to the at least one connecting structure, and the material of the at least one second shaft portion is the same as the material of the at least one connecting structure.

4. The vibration optical module according to claim 2, wherein the base, the first frame, and the second frame are integrally formed.

5. The vibration optical module according to claim 2, wherein the second frame is connected to the base in a non-screw-mounting manner.

6. The vibration optical module according to claim 1, wherein the vibration optical module further comprises at least one connecting structure, wherein the at least one connecting structure is disposed on the base, the at least one first shaft portion is connected to the at least one connecting structure, and the material of the at least one first shaft portion is the same as the material of the at least one connecting structure.

7. The vibration optical module according to claim 1, wherein the base and the first frame are integrally formed.

8. The vibration optical module according to claim 1, wherein the first frame is coupled to the base in a non-screw-mounting manner.

9. The vibration optical module according to claim 1, wherein the first frame comprises a first frame portion and a second frame portion, the first frame portion and the second frame portion are connected to each other and surround the optical component together, the at least one first shaft portion is formed on the first frame portion, the material of the at least one first shaft portion is the same as the material of the first frame portion, and the Young's modulus of the material of the second frame portion is higher than the Young's modulus of the material of the first frame portion and the at least one first shaft portion.

10. The vibration optical module according to claim 9, wherein the first frame portion comprises two first sidewalls opposite to each other, the second frame portion comprises two second sidewalls opposite to each other, and each of the two first sidewalls is connected between the two second sidewalls.

11. A projector, comprising a light source, a light valve, a projection lens and a vibration optical module, wherein,
the light source is adapted to provide an illumination beam,
the light valve is adapted to convert the illumination beam into an image beam,
the projection lens is adapted to project the image beam, and
the vibration optical module is disposed between the light valve and the projection lens and comprises a base, a first frame, an optical component, and an actuating assembly, wherein,
the first frame has at least one first shaft portion, wherein the first frame is connected to the base at least by the at least one first shaft portion,
the optical component is disposed in the first frame, and
the actuating assembly is disposed on the base,
wherein the Young's modulus of the material of the base is higher than the Young's modulus of the material of the at least one first shaft portion, and the actuating assembly drives the first frame to drive the optical component to vibrate back and forth relatively to the base within an angle by elastic deformation of the at least one first shaft portion.

12. The projector according to claim 11, wherein the vibration optical module further comprises a second frame, the first frame is disposed in the second frame and connected to the second frame by the at least one first shaft portion, the second frame has at least one second shaft portion, the second frame is connected to the base at least by the at least one second shaft portion, the actuating assembly drives the second frame to drive the optical component to vibrate back and forth relatively to the base within an angle by elastic deformation of the at least one second shaft portion, and the Young's modulus of the material of the base is higher than the Young's modulus of the material of the at least one second shaft portion.

13. The projector according to claim 12, wherein the vibration optical module further comprises at least one connecting structure, the at least one connecting structure is disposed on the base, the at least one second shaft portion is connected to the at least one connecting structure, and the material of the at least one second shaft portion is the same as the material of the at least one connecting structure.

14. The projector according to claim 12, wherein the base, the first frame and the second frame are integrally formed.

15. The projector according to claim 12, wherein the second frame is connected to the base in a non-screw-mounting manner.

16. The projector according to claim 11, wherein the vibration optical module further comprises at least one connecting structure, the at least one connecting structure is disposed on the base, the at least one first shaft portion is connected to the at least one connecting structure, and the material of the at least one first shaft portion is the same as the material of the at least one connecting structure.

17. The projector according to claim 11, wherein the base and the first frame are integrally formed.

18. The projector according to claim 11, wherein the first frame is connected to the base in a non-screw-mounting manner.

19. The projector according to claim 11, wherein the first frame comprises a first frame portion and a second frame portion, the first frame portion and the second frame portion are connected to each other and surround the optical component together, the at least one first shaft portion is formed on the first frame portion, the material of the at least one first shaft portion is the same as the material of the first frame portion, and the Young's modulus of the material of the second frame portion is higher than the Young's modulus of the material of the first frame portion and the at least one first shaft portion.

20. The projector according to claim 19, wherein the first frame portion comprises two first sidewalls opposite to each other, the second frame portion comprises two second sidewalls opposite to each other, and each of the two first sidewalls is connected between the two second sidewalls.
